(19) United States
(12) Patent Application Publication
(10) Pub. No.: US 2009/0265719 A1
(43) Pub. Date: Oct. 22, 2009

(54) APPLICATION MACRO RECORDING UTILIZING METHOD INTERCEPTION

(75) Inventors: Henricus Johannes Maria Meijer, Mercer Island, WA (US); Jeffrey Van Gogh, Redmond, WA (US); John Wesley Dyer, Monroe, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/105,335

(22) Filed: Apr. 18, 2008

(51) Int. Cl. G06F 9/54

(52) U.S. Cl. 719/320

(57) ABSTRACT

Method interception is utilized to generate macros. A recorder is injected within application code. The recorder intercepts a call to a method, captures information, and calls the original method. A macro can be generated subsequently as a function of the captured information. In one instance, macros can be utilized to test the application code. Additionally, information capture and ultimately macro generation can be combined with a tier splitting mechanism.

### BACKGROUND

A macro originally referred to a mechanism to facilitate execution of sequences of instructions in assembly languages. More specifically, a macro defined how a single language statement was to be expanded into multiple instructions. Upon execution or processing of the single language statement, the set of instructions captured by the macro would be injected inline with the code. These macros saved time by relieving programmers of the tedious process of continually specifying frequently used sequences of instructions. Furthermore, macro employment reduced the likelihood of clerical type error introduction brought about from repeated manual specification of sequences of instructions. Hence, macros were found to make programming easier and produce less error-prone code.

As higher level programming languages became more common, macros escaped the small confines of assembly languages. These macros, often referred to as application macros or application scripts, enable recording of keyboard and/or mouse actions to automate frequent or repetitive actions. By way of example, use of macros became quite popular in office applications such as spreadsheet and word processing applications as a short cut for specification of repetitive keyboard and/or mouse input. For similar reasons, macros have also become popular in gaming and specifically multi-player online gaming as a mechanism for executing repetitive sequences of keyboard and/or mouse commands to perform some useful action.

Prior to utilizing a macro, it must first be generated. In other words, a sequence needs of actions, commands or the like need to be recorded. Currently, there are two ways to generated a macro, namely by action or code. For example, recorders can record user interactions with input devices such as a mouse and/or keyboard. Alternatively, the sequence of actions can be manually specified by a programmer. The sequence of recorded actions forms the macro.

Macro systems generally need to build in the ability to record macros by adding crosscutting code to a program. Accordingly, there can be a lot of up front cost associated with macro support. For instance, some applications include a special macro programming language usually a script with direct access to application features to enable recording and replay of macros. Further, these macro languages can be designed and built-in to a suite or group of related applications such as an office suite including word processor and spreadsheet functionality, among others. Other systems utilize a less intimate approach of simply listening to and recording message pumps.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to recording, generating, and utilizing application macros. Recording is enabled in arbitrary applications by way code injection and method interception. Recorders are injected statically and/or dynamically into an application that intercept calls to methods, capture information, and call the methods. In accordance with one embodiment, such code injection can form part of a tier-splitting code generator or re-writer. Macros can then be generated from the captured information to enable replay of recorded action. The macro can subsequently be executed to control the application. In one instance, macros can be generated and utilized to facilitate application testing.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of macro recording system in accordance with an aspect of the disclosure.

FIG. 2 is a block diagram of a representative recorder component according to a disclosed aspect.

FIG. 3 is a graphical illustration of an exemplary use of a recorder component in accordance with a disclosed aspect.

FIG. 4 is a block diagram of a system of macro generation in accordance with an aspect of the disclosure.

FIG. 5 is a block diagram of a macro generation system according to a disclosed aspect.

FIG. 6 is a block diagram of a macro recording system according to an aspect of the disclosure.

FIG. 7 is a flow chart diagram of a method of macro recording according to a disclosed aspect.

FIG. 8 is a flow chart diagram of a method of macro recording utilizing interception in accordance with an aspect of the disclosure.

FIG. 9 is a flow chart diagram of a macro generation method according to a disclosed aspect.

FIG. 10 is a flow chart diagram of a method of application testing utilizing a generated macro in accordance with a disclosed aspect.

FIG. 11 is a schematic block diagram illustrating a suitable operating environment for aspects of the subject disclosure.

FIG. 12 is a schematic block diagram of a sample-computing environment.

### DETAILED DESCRIPTION

Systems and method pertaining to macros are described in detail hereinafter. Information can be captured for use in macro generation employing method interception. One or more recorders can be injected within an application that intercept calls to methods or the like, capture some pertinent information, and then make calls to originally targeted methods. In this manner, macros can record information with respect to arbitrary applications rather than requiring an application to anticipate macro recording and provide a built-in infrastructure. Macros can be generated subsequently as a function of the information captured by the recorders. A generated macro can then be utilized to control an application for example in an attempt to test the application. Further, mechanisms associated with macro recordation and production can be combined with code generation or rewriting components including a tier split component.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

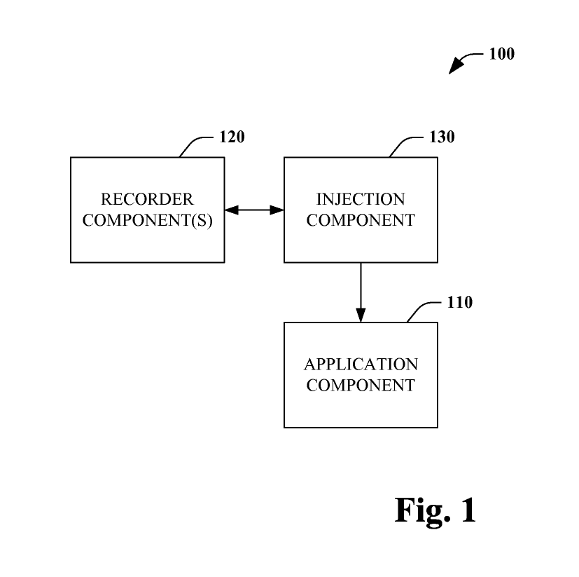

Referring initially to FIG. 1, a macro recording system 100 is illustrated in accordance with an aspect of the claimed subject matter. System 100 includes application component 110, recorder component 120, and injection component 130. The application component 110 can correspond to any computer (or other processor based device) application, program, or the like including application and/or system software. In one particular implementation, the application 110 can be a web or web-based application as will be described further infra. The recorder component 120 is a mechanism that records data and/or information about application execution. For example, a plurality of recorder components 120 or instances thereof can capture information about an execution path dictated by user interaction.

The injection component 130 injects one or more recorder components 120 into the application component 110. In one implementation, the injection component adds recorder components to source code statically and/or dynamically. In other words, the application component 110 can be instrumented with recorder components 120 prior to or at runtime. The functionality specified by the application component 110 need not be changed but rather can be supplemented with additional recording functionality. Consequently, source code does not need to be accessible and modifiable. Furthermore, the application component 110 need not anticipate recording and provide supporting infrastructure to facilitate recording. Recorder components 120 can be injected in a myriad of manners depending on a particular type or class of applications and/or execution environments. For example, where an application is aspect oriented advice can be specified. Additionally or alternatively, script can be injected within an application executing in a web browser to effect recording.

In accordance with an aspect of the claimed subject matter, the recorder component 120 can capture execution information via method interception. Actions can be captured at various levels of granularity. At a high-level accessibility application programming interfaces (APIs) can be monitored. At a lower level, window messages can be intercepted. Both are rather isolated from the application itself. For example, interception of window messages is too generic to allow drilling into the application. Accordingly, if a developer decided to move a button slightly recordation would be inaccurate. Rather than going to either extreme, recorders can be injected at the application method level to capture events and method invocations in accordance with an aspect of the claimed subject matter. This is especially useful in a testing scenario. Furthermore, it can avoid differences in execution environments and/or versions of the same environment.

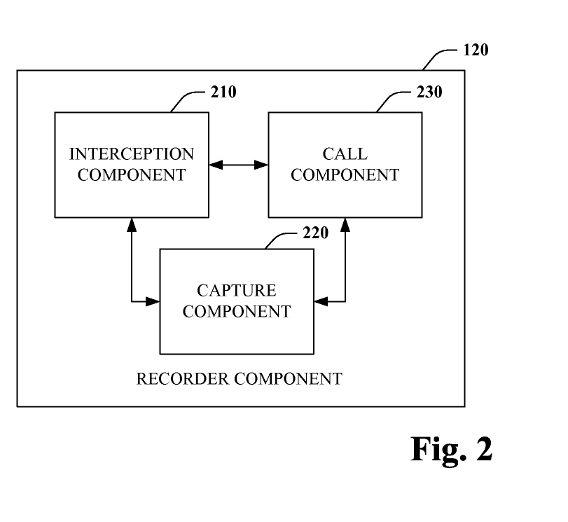

FIG. 2 illustrates a representative recorder component 120 in accordance with an aspect of the claimed subject matter. Interception component 210 intercepts calls directed to one or more methods, functions or the like. Data or information is recorded by capture component 220. Captured information can include information identifying the method that was invoked, application state, and/or events, among other things. The capture component 220 can record captured information in memory and/or to a persistent store. In according with one aspect, the capture component 220 can also inspect or initiate inspection of a runtime call stack to enabling filtering or identification of calls appropriate for capture (e.g., user calls). The call component 230 calls or invokes the method that was intercepted. In this manner, the application is unaware that a call was intercepted and information recorded.

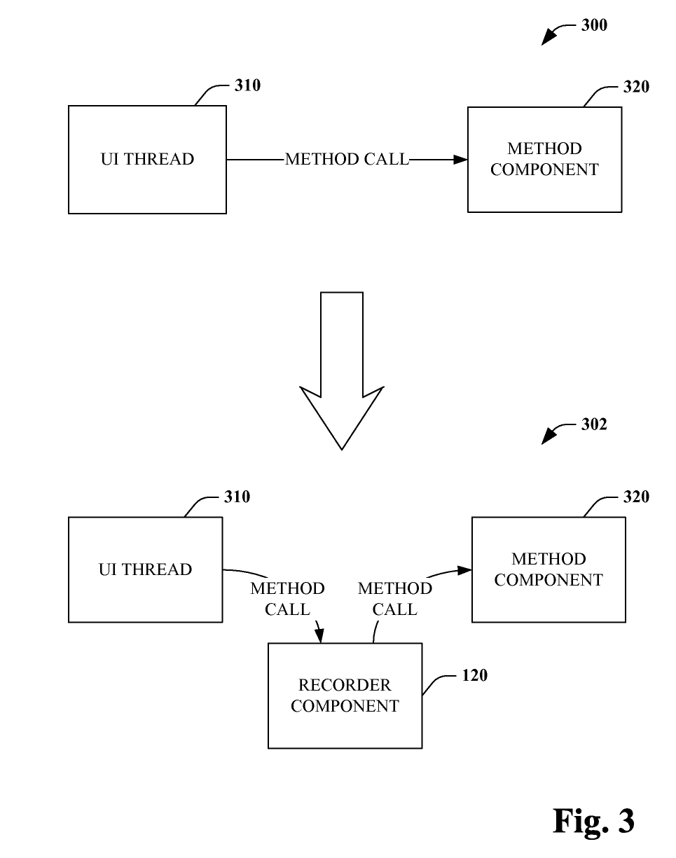

FIG. 3 is a graphical depiction of the difference between original and intercepted method call scenarios. In this exemplary case, a program involves a user interface (UI) that includes a number of methods, which are implemented to handle incoming UI events. A typical example in pseudo code would look as follows:

Void OnClick(EventArgs ea)
{
//perform action
}

In the first scenario 300, a UI thread 310 calls a method component 320. The UI thread 310 is of course only one way to call a method 310. However, in a UI testing context, for example, this can be the manner in which a many methods 310 are called. The second scenario 302 again shows the UI thread component 310 and the method component 320. In addition, a recorder component 120 is positioned between the thread and the method. As shown, the recorder component 120 intercepts the method call from the UI thread component 310 and then makes the call to the method 320. Prior to calling the method 320, the recorder component 120 can record the “click” and specific method invocation, among other things. In one instance, the recorder component 120 can intercept calls and produce method calls to a number of methods.

It is to be appreciated that the recorder component 120 can be injected at various positions within an application. In effect, the recorder component 120 acts as an interception layer that intercepts calls and records information at a point of injection. Accordingly, the recorder component 120 is not limited to capturing information prior to method execution. It could also record information after a method has executed or before and after method execution. For example, a recorder component 120 can intercept a method a method call from method component 320 to another method to capture state both before and after method execution.

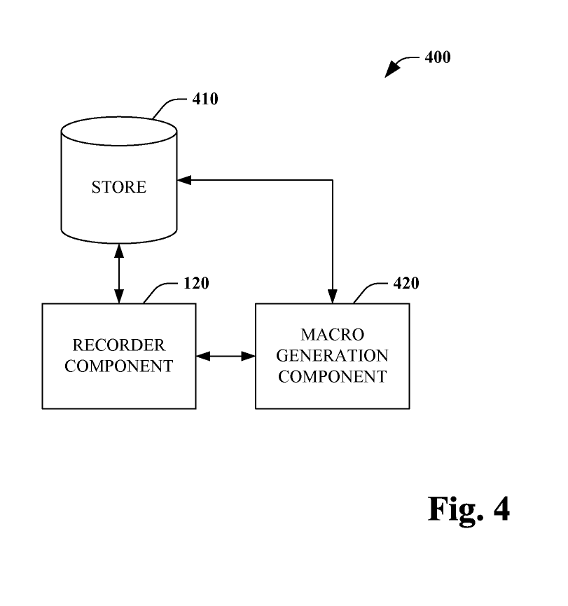

Turning attention to FIG. 4, a macro generation system 400 is illustrated in accordance with an aspect of the claimed subject matter. As shown, the system includes the recorder component 120, as previously described. In brief, the recorder component 120 captures information via method interception before and/or after method execution. For example, the recorder can identify a method called and arguments employed therewith and/or current application state. The data/information captured by the recorder component 120 can either be housed temporarily in memory, for example, or persisted to a store 410. Macro generation component 420 can receive, retrieve, or otherwise acquire recorded information from the recorder component 120 and/or the store 410. Upon acquisition, the macro generation component 420 produces a macro or script capable of replaying captured actions upon processing or execution. For example, if function “A” was called first followed by function “B,” then that same sequence of function calls can be generated by the macro generation component 420.

By way of example, a developer may desire to generate a test to examine a web application. Conventionally, scripts would need to be generated that drive the UI on an HTML page. For example, the following code can be employed to automate a browser to “type in” a search box, “click” a button, and check that results are as expected:

[Test]

```
public void Search( )
{
  using (Browser br = new Browser(“http://www.example.com”))
  {
    br.TextField(Find.ByName(“q”)).TypeText(“Test”);
    br.Button(Find.ByName(“btnG”)).Click( );
    Assert.IsTrue(br.ContainsText(“Test”));
  }
}
```

However, writing scripts like the above can be tedious and prone to error. Here, however, a developer can simply initiate recording, find the search box, type in the text and click the button. This action can then be captured by the recorder component 120 and macro generation component 420 can generate such code automatically. It is to be noted that the complete code can be generated or a skeleton code can be produced. In this example, the actions could be generated and the check (“Assert.IsTrue”) can be left open for developer to input an expected value, here “Test.” In any event, test generation has been substantially improved over conventional manual specification.

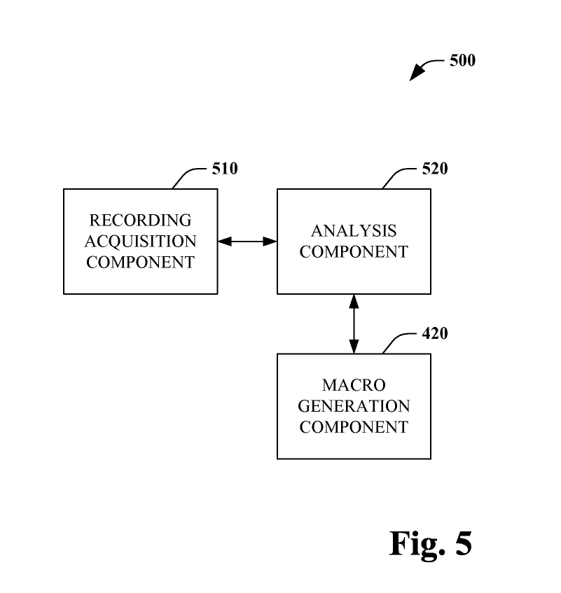

Turning to FIG. 5, a macro generation system 500 is depicted in accordance with an aspect of the claimed subject matter. As previously described, the macro generation component 420 generates a macro or code as a function of recorded actions. For example, test code can be generated for a UI based on manual interaction with the UI. The system 500 also includes a recording acquisition component 510 communicatively coupled with an analysis component 520. The recording acquisition component 510 acquires a set of actions related to the single desired recording and provides them for analysis to analysis component 520. In some instances, a user may desire to run through the test manually multiple times to ensure the correct and most appropriate test is generated. The analysis component 520 analyzes these sequences of actions to identify differences and/or potential points of generalization, inter alia, that can be identified to the macro generation component 420. In one embodiment, pattern-matching techniques can be employed as a means to this end.

For instance, the analysis component 520 can identify and resolve timing issues. Often when interacting with web applications, to specify a test for example, a user will pause until certain elements become visible in the UI and then he/she will make another move. The analysis component 520 can determine or infer that the action is dependent upon element visibility and not a particular wait time. The macro generation component 420 can then generate a macro or code corresponding to an identified sequence and/or in accordance with information provided by the analysis component 520.

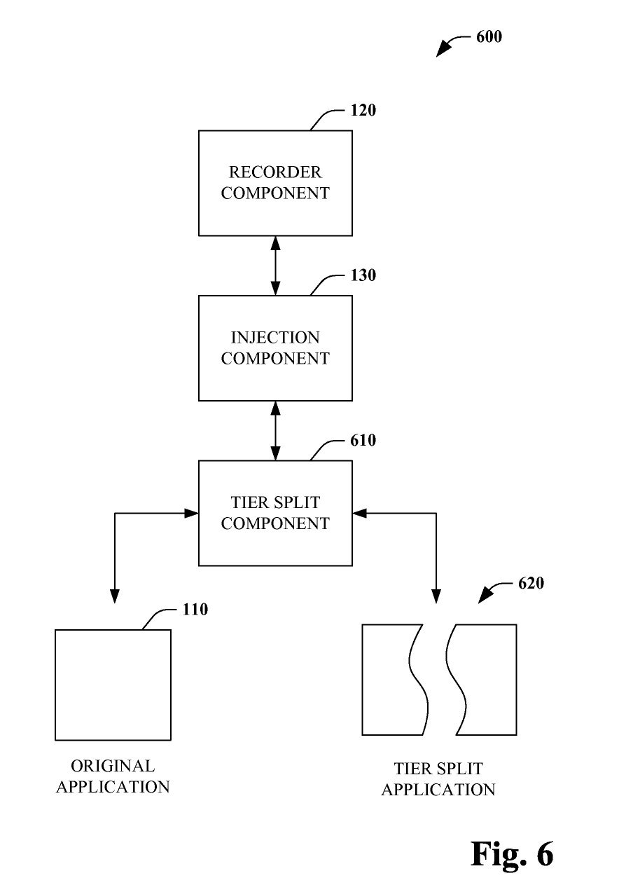

Referring to FIG. 6, a macro recording system 600 is illustrated in accordance with an aspect of the claimed subject matter. The system 600 includes the recorder component 120 and injection component 130 as previously described with respect to system 100 of FIG. 1. In sum, the recorder component 120 is a mechanism for capturing information about application execution by way of method interception. The injection component 130 injects one or more recorder components 120 within an application 110 to record information at particular points.

The system 600 also includes a tier split component 120 that facilitates splitting, slicing, or otherwise partitioning an application in a variety of ways. Generally, the tier split component 610 can partition a single application for execution across multiple execution contexts. In one particular instance, the tier-split component 610 can transform a single tier application 110 into a multiple tier application 620 suitable for distributed processing. This can be accomplished automatically; however, support manual or semi-automatic operation is also possible. Moreover, it is to be appreciated that tier split component 610 splits an application in a manner that preserves program semantics. Accordingly, split application execution is semantically equivalent to sequential execution of the application on a single tier. In one embodiment, the tier split component 610 can correspond to a distributing compiler.

The tier split component 610 is communicatively coupled with the injection component 130. Accordingly, recorder components 120 can be injected within an application as part of a tier splitting process. Since tier splitting is essentially a special code generation process, this provides a good point for injection of macro recording. Here, recording can occur across tiers. For example, suppose an application 110 is split into a two-tier application 620 and a call is made from a client tier to a server tier. Now, a recorder can be injected to intercept the call, record interesting information for a macro generator, and then make the original call.

In accordance with one aspect, an indication can be provided as to which methods should be split across tiers by the tier split component 610. For instance, an attributed can be included on a method indicating it is for client or server execution. Injection points can be identified in a similar manner. For example, a declarative attribute associated with a method can indicate that recording should be performed thereon. In the absence thereof, a default can be employed such as recording all user interface related methods.

It is to be appreciated that while the aforementioned systems are described with respect to a recorder component 120 including an interception subcomponent 210, aspects of the claimed subject matter can be implemented in varying manners. For instance, rather than including the interception component 210 as a subcomponent, the injection component 130 can inject an interception component 210 that calls a recorder component 120, and then makes or initiates a call of the method that was intercepted.

Further yet, it is to be noted that the recording and/or macro can be executed in a separate process or thread from the associated application. In this manner, problems (e.g., hanging, crashing . . . ) with the application will not affect recording or macro execution. Consider the testing process for instance. Here, crashing or hanging might be desired. As such, if an application crashes, the recorder should not crash. Similarly, during execution of a generated test, an application crash should not render the test impotent. To the contrary, it should capture the fact that the application crashed. Additionally, separation of macro recording and/or generation from an application minimizes disturbance of the application that may lead to unexpected or undesirable results.

It is also to be noted that recorded input need not be provided by a human user interacting with a user interface. In another embodiment, input can be provided by sensors. For example, in a robotics context, sensors and output mechanisms could be instrumented in accordance with aspects of the disclosure. Basically, the functions being invoked by sensor input can be intercepted and recorded to enable a macro to be generated to playback a sequence of repeatable steps.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the analysis component 520 can utilize such mechanisms to generate smart recordings. Similarly, injection component 130 can employ such techniques to determine or infer locations for recorder injection.

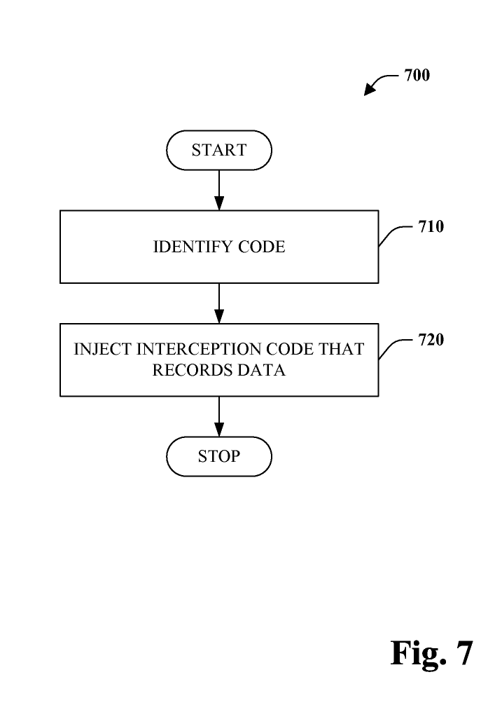

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a flow chart diagram of a method of macro recording 700 is illustrated in accordance with an aspect of the claimed subject matter. At reference numeral 710, code is identified associated with a computer or other processor based device application. In accordance with one aspect, application code need not anticipate recording or macro interaction via supporting infrastructure. Rather, the identified code can be associated with any arbitrary application. At numeral 720, code is injected to facilitate recording for example utilizing method interception or an interception layer. Injection can be accomplished statically and/or dynamically. In accordance with one implementation, code injection can form part of a code generation and/or rewriting processes including but not limited to a tier-splitting process. Additionally or alternatively, the code can be injected by way of an aspect oriented mechanism or support for injection in a particular execution context (e.g., web browser script support). For web applications, for example, script libraries (e.g., JavaScript DHTML) associated with particular browsers can be dynamically instrumented to perform recording.

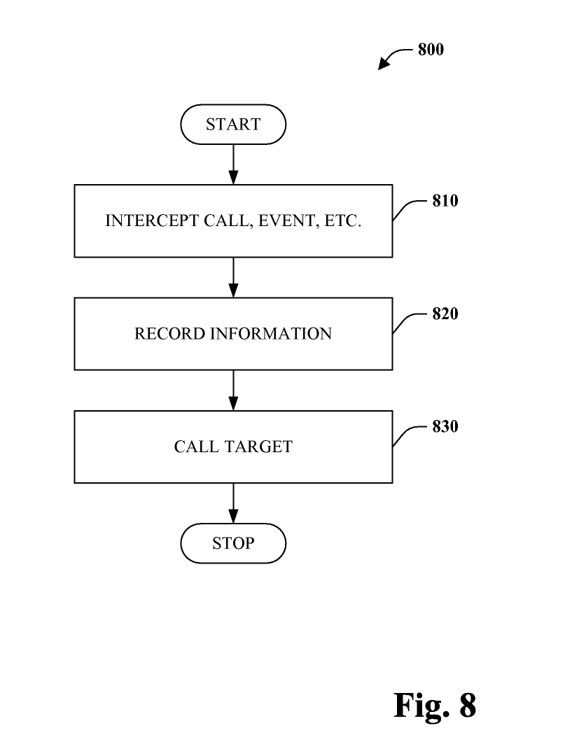

FIG. 8 depicts a method of macro recording in accordance with an aspect of the claimed subject matter. At reference numeral 810, a method call, event, and/or the like is intercepted during application execution. At numeral 820, information is recorded including but not limited to application state such as identity of method called, arguments, and/or results. In accordance with one aspect, it is to be noted that where multiple entities are interacting with an application, it may be necessary to inspect a call stack to enable filtering of calls based on responsible entity. For example, in this manner only user originating calls can be captured while all others are filtered out. At reference 830, the call to a targeted method, or the like is made to invoke such a programmatic construct as would have been done absent the interception. This interception and recording can happen at various points in an application including at the beginning, end, or both of a method invocation. By performing recording at the application method/function level pertinent application information can be acquired. The level of information granularity is especially helpful for macros or scripts associated with tests or simply tests.

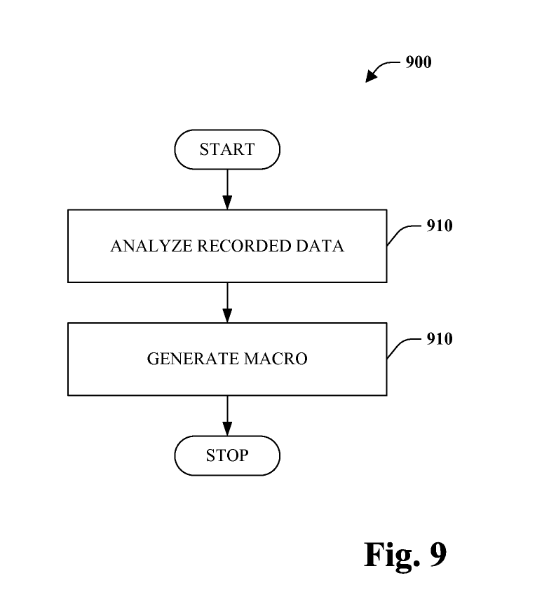

Turning attention to FIG. 9, a method of macro generation 900 is illustrated in accordance with an aspect of the claimed subject matter. At reference numeral 910, recorded data is analyzed. Such analysis can include identification and optionally resolution of issues or differences revealed across one or more recordings of a set of actions. In one instance, this can correspond to application of various pattern matching technologies seeking to determine, infer, or otherwise identify issues. For example, analysis amongst multiple recordings of the same set of actions can reveal that a delay is a user timing issue, or alternatively the delay is a result of waiting for the appearance of a particular graphical element. In other words, the analysis can afford mechanisms to ensure that the intent of an action or actions is captured as accurately is possible. At reference numeral 910, a macro is generated as a function one or more recorded action sequences and the analysis thereof. In accordance with one aspect, this can correspond to generation of test code or a portion of test code.

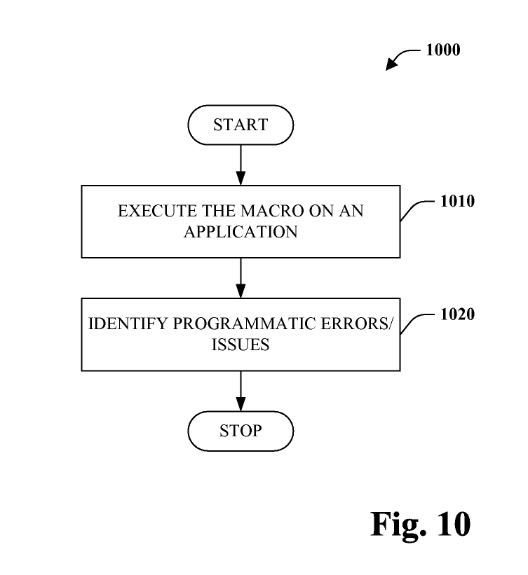

FIG. 10 is a flow chart diagram of a method 1000 of macro employment according to an aspect of the claimed subject matter. Subsequent to recordation and generation, a macro can be executed on an application at reference numeral 1010. Execution involves replaying or re-executing previously recorded actions. In accordance with an aspect of the claims, the macro performs test functionality based on previously recorded human interaction. At reference numeral, 1020, programmatic errors or issues are identified as a result of the macro execution. In this manner, a test can be specified once by a user, recorded and replayed several times to facilitate application development and/or debugging, among other things.

The terms “method” and “function” are utilized interchangeably herein. A “function” conventionally refers to a piece of code that performs an operation. On the other hand, a “method” is a function on an object. In practice as well as herein, however, the terms are used interchangeably to refer simply to a piece of code that specifies a specific routine or operation regardless of whether an object is involved or not.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

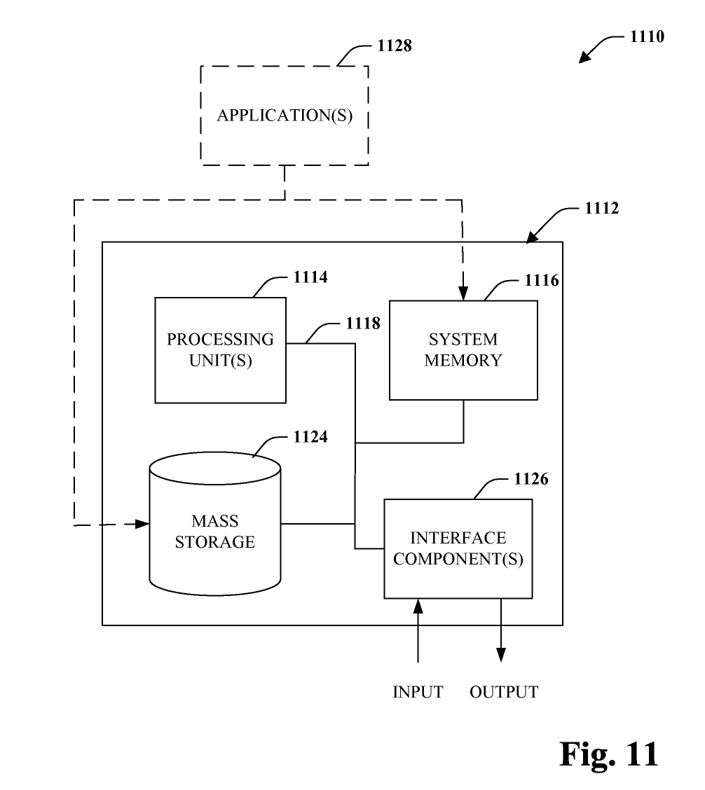

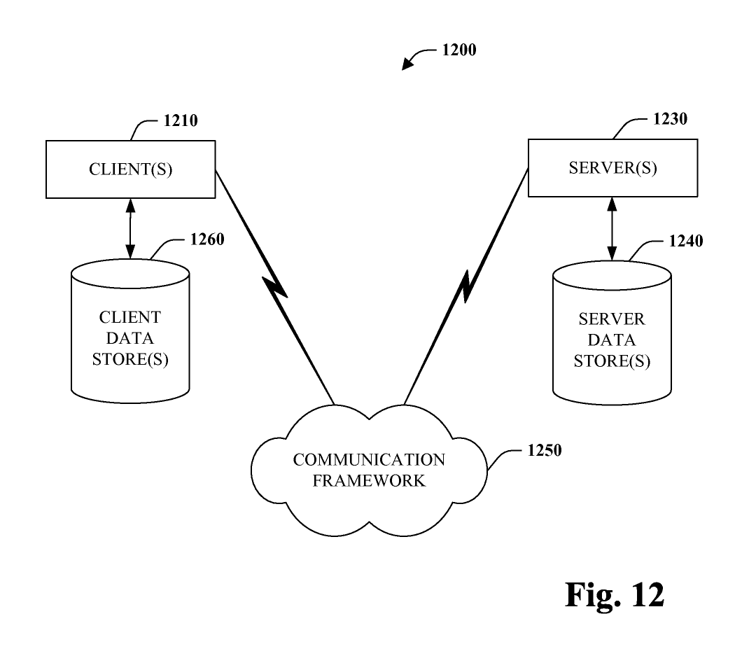

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory, or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g., CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

Client/server interactions can be utilized with respect with respect to various aspects of the claimed subject matter. By way of example and not limitation, macro recording can be injected to capture calls across client(s) 1210 and servers 1230. For instance, as part of a macro recording process a call from a client 120 to a server 1230 across communication framework 1250 can be intercepted to record useful macro generation information before and/or after method invocation.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. An application macro system, comprising:
a recorder component; and
an injection component that injects the recorder component within a context of an arbitrary software application, the recorder component intercepts a call to an application method, captures action, and calls the method.

2. The system of claim 1, further comprising a macro generation component that generates a replayable macro as a function of the captured action.

3. The system of claim 2, further comprising a component that detects differences in actions executed multiple times and identifies a generalized action to the macro generation component.

4. The system of claim 2, the macro is an application test.

5. The system of claim 4, the recorder component intercepts and captures invocation of user interface related method calls.

6. The system of claim 5, the recorder component inspects a runtime call stack to filter out calls that are not from a user.

7. The system of claim 1, the application is specified in virtual machine code that is transformed to native code at runtime.

8. The system of claim 7, the application is a web browser script application.

9. The system of claim 8, the method is located in a dynamic hypertext markup language (DHTML) library.

10. The system of claim 1, further comprising a tier split component that splits the application into two or more parts for execution across multiple execution contexts.

11. A macro method, comprising:
identifying an application; and
injecting code to capture application actions during execution utilizing method interception.

12. The method of claim 11, further comprising recording method invocation.

13. The method of claim 11, further comprising recording state prior to and/or after method invocation.

14. The method of claim 11, further comprising capturing user interface related method calls.

15. The method of claim 11, further comprising generating a macro from the captured actions.

16. The method of claim 15, further comprising executing the macro to test the application.

17. The method of claim 11, further comprising injecting the code in conjunction with a tier splitting operation.

18. A macro system, comprising:
means for splitting code across execution contexts; and
means for injecting recording code into the split code that intercepts a call to a user interface related method, captures information related thereto and calls the method.

19. The system of claim 18, further comprising a means for generating a macro as a function of the recorded information to test the split code.

20. The system of claim 18, the code is split between a server application and a client web application.
